(19) United States
(12) Patent Application Publication
(10) Pub. No.: US 2026/0176075 A1
(43) Pub. Date: Jun. 25, 2026

(54) WHEELLESS DOLLY FOR CASTER DECK FLOOR

(71) Applicant: Federal Express Corporation, Memphis, TN (US)

(72) Inventors: Jérôme Gillette, Menucourt (FR); Valérie Jeunet, Orry la Ville (FR); Clément Jean Louis Renard, Boulogne-Billancourt (FR); Hakim El Miloudi, Creil (FR); Alexandre Behloul, MONTATAIRE (FR); Ayélé Afanou, AUNEUIL (FR); Marc Menant, Saint Thibault des Vignes (FR)

(21) Appl. No.: 19/427,433

(22) Filed: Dec. 19, 2025

Related U.S. Application Data
(60) Provisional application No. 63/736,476, filed on Dec. 19, 2024.

(51) Int. Cl. B65G 7/02; B65G 13/00

(52) U.S. Cl. CPC B65G 7/02; B65G 13/00

(57) ABSTRACT

A wheelless dolly configured for use with a caster deck floor, and processes for operating the wheelless dolly. The wheelless dolly including a planar base that is tapered at a first end, and an upright structure coupled to the planar base at a second end opposite the first end. The structure including a first portion extending upwards from a top surface of the planar base, a second portion angled relative to the first portion in a direction away from the second end of the planar base, and a third portion coupled to the second portion extending laterally across the second portion, thereby forming a handle configured for maneuvering the wheelless dolly along the caster deck floor. Other embodiments are disclosed.

### CROSS-REFERENCE TO RELATED APPLICATION

This application claims the benefit under 35 U.S.C. § 119(e) of U.S. Patent Application No. 63/736,476, entitled “Wheelless Dolly For Caster Deck Floor,” filed Dec. 19, 2024, which is incorporated herein by reference in its entirety.

### BACKGROUND

Containers and pallets are used in the transportation industry to consolidate, protect, and transport cargo. These containers and/or pallets are designed to be easily loaded and unloaded from vehicles (e.g., aircraft, trains, trucks, etc.), improving efficiency in cargo handling and logistics. The loading and unloading of containers and/or pallets, as well as the movement of other heavy loads within transportation and logistics facilities, often requires specialized equipment and careful maneuvering. Traditional methods of moving pallets and containers are cumbersome, time-consuming, and potentially hazardous to workers. The use of forklifts or powered pallet jacks, while effective, is not always suitable in confined spaces or areas with limited maneuverability.

### SUMMARY

The present disclosure relates to a wheelless dolly configured for use with a caster deck floor. The wheelless dolly includes a planar base that is tapered at a first end, and an upright structure coupled to the planar base at a second end opposite the first end. The structure including a first portion extending upwards from a top surface of the planar base, a second portion angled relative to the first portion in a direction away from the second end of the planar base, and a third portion coupled to the second portion extending laterally across the second portion, thereby forming a handle configured for maneuvering the wheelless dolly along the caster deck floor.

In some implementations, the planar base further includes a top surface including a first portion configured for carrying packages and a second portion that is tapered at the first end, and a bottom surface, wherein the bottom surface of the planar base is flat.

In some implementations, the first portion of the top surface is flat and configured for carrying at least one of a pallet, or a load.

In some implementations, the second portion is tapered at an angle between 5 degrees and 40 degrees.

In some implementations, the first portion of the upright structure is coupled to the planar base via the top surface adjacent a first side of the planar base and extends perpendicular to the top surface.

In some implementations, the second portion of the upright structure is angled relative to the top surface of the base at an angle between 5 degrees and 45 degrees and extends beyond the first side of the base to enable an individual to operate the wheelless dolly to mitigate the individual from engaging the planar base.

In some implementations, the handle of the third portion of the upright structure includes a surface that an individual operating the wheelless dolly can interact with to maneuver the dolly within the caster deck floor.

In some implementations, the present disclosure includes a system for moving packages including a caster deck floor including a floor with a first type of wheel and a dock with a second type of wheel and a wheelless dolly. The wheelless dolly including a planar base that is tapered at a first end of the planar base, and an upright structure coupled to the planar base at a second end of the planar base opposite the first end.

In some implementations, the first type of wheel enables operation of the wheelless dolly within a 360-degree range of motion.

In some implementations, the second type of wheel is a roller wheel that enables forward and rearward operation of the wheelless dolly within the dock.

In some implementations, the dock includes a recess and an elevated surface, the recess housing the second type of wheel.

In some implementations, the planar base includes a top surface, wherein the dock is configured to house a pallet, and the top surface of the planar base is configured to create a friction fit with a bottom surface of the pallet, wherein a top surface of the pallet is at the same height as the elevated surface to enable placement of items on the pallet.

In some implementations, the planar base of the wheelless dolly includes a top surface with a first portion that is flat and configured for carrying packages, and a second portion that is tapered at the first ed of the planar base.

In some implementations, the tapered portion of the planar base is angled to enable the wheelless dolly to be positioned under the pallet in the recess and engage the bottom surface of the pallet with the first portion of the top surface of the planar base.

In some implementations, the present disclosure includes a method of moving a pallet using a wheelless dolly, the method including maneuvering the wheelless dolly into a dock of a caster deck floor, the dock including a recess with a second type of wheel. In some implementations, the method includes sliding the wheelless dolly underneath the pallet in the recess. In some implementations, the method includes engaging a bottom surface of the pallet with a first portion of a top surface of a planar base of the wheelless dolly. In some implementations, the method includes removing the pallet from the dock using the wheelless dolly.

In some implementations, the method further includes maneuvering the dolly with the pallet on a floor of the caster deck floor, the floor including a first type of wheel enabling operation of the wheelless dolly within a 360-degree range of motion.

In some implementations, the second type of wheel is a roller wheel that enables forward and rearward operation of the wheelless dolly within the dock.

In some implementations, the dock includes an elevated surface, and a top surface of the pallet is at the same height as the elevated surface to enable placement of items on the pallet.

In some implementations, the planar base of the wheelless dolly includes a tapered portion angled to enable the wheelless dolly to be positioned under the pallet in the recess of the dock.

In some implementations, the wheelless dolly includes an upright structure with a first portion extending upwards from a top surface of the planar base, a second portion angled relative to the first portion in a direction away from the second end of the planar base, and a third portion coupled to the second portion, thereby forming a handle for maneuvering the wheelless dolly.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example facility with an example wheelless dolly and caster deck floor.

FIG. 2A depicts the wheelless dolly of FIG. 1 positioned under a pallet.

FIG. 2B depicts the wheelless dolly of FIG. 1 positioned under the pallet on the caster deck floor.

FIG. 3A depicts a front view of the wheelless dolly of FIG. 1.

FIG. 3B depicts a side view of the wheelless dolly of FIG. 1.

FIG. 4 depicts a rear perspective view of the wheelless dolly of FIG. 1.

FIG. 5 depicts an alternative embodiment of the wheelless dolly.

FIG. 6 illustrates a flowchart of an example method, according to embodiments disclosed herein.

Like reference numbers and designations in the various drawings indicate like elements.

### DETAILED DESCRIPTION

The present disclosure relates to a wheelless dolly and caster deck floor system for efficiently maneuvering pallets and loads within a facility. This system provides advantages in loading and unloading Unit Load Devices (ULDs) as well as moving various types of loads such as packages and products. The wheelless dolly can be operated by an individual to maneuver pallets within the caster deck floor, enabling smooth and safe movement in multiple directions.

The facility described herein may be used for loading ULDs, which are standardized containers designed for use in various transportation modes. ULDs may be utilized in aircraft operations and can be loaded onto different types of vehicles, storage units, or transfer devices. The wheelless dolly allows for efficient handling of diverse materials and products across various stages of transportation and logistics operations.

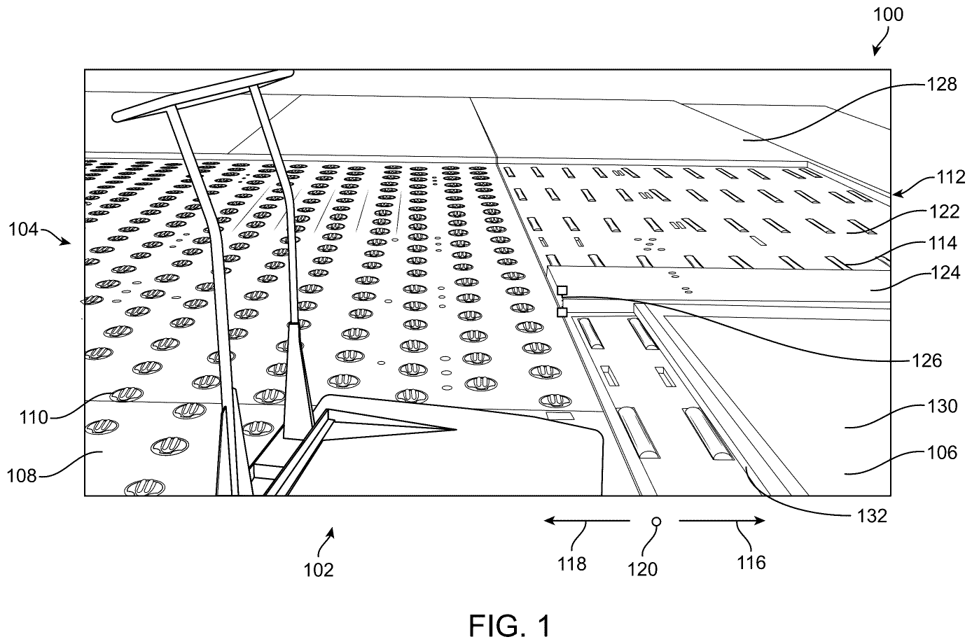

FIG. 1 depicts an example facility 100 with an example wheelless dolly 102, a caster deck floor 104, and a pallet 106.

The facility 100 is used for loading and/or unloading ULDs that can be used for aircraft or different types of vehicles. The facility 100 can also be utilized for different types of storage units or transfer devices. For example, the facility 100 can be used for packed products (e.g., products in containers), loose products (e.g., items that are not in containers), and various types of products (e.g., consumable, perishable, hazardous materials, etc.). Various combinations of these products can be referred to herein as loads, which can be carried by the wheelless dolly 102, or the pallet 106 that is maneuvered by the wheelless dolly 102.

The caster deck floor 104 includes a floor 108 with a first type of wheel 110 and a dock 112 with a second type of wheel 114. The first type of wheel 110 is a caster wheel. The first type of wheel 110 enables operation of the wheelless dolly 102 within a 360-degree range of motion. For example, the first type of wheel 110 can be a ball transfer unit or a swivel caster that allows for multidirectional movement of the wheelless dolly 102 across the floor 108.

The caster deck floor 104 includes a dock 112 that includes a recess 122 and an elevated surface 124. The recess 122 housing the second type of wheel 114. The second type of wheel 114 is a roller wheel that enables forward operation in the forward direction 116 and rearward operation in the rearward direction 118 of the wheelless dolly 102 within the dock 112 relative to a transition point 120. The transition point 120 defines a boundary between the floor 108 and the dock 112. In some implementations, the second type of wheel 114 can be a cylindrical roller or a conveyor roller that facilitates linear movement within the dock 112.

The elevated surface 124 can be at a height 126 that is the same as a height of a walking surface 128 of the dock 112. The walking surface 128 may enable individuals to walk around the floor 108 and the recess 122 without interacting with the first type of wheel 110 and the second type of wheel 114.

In some implementations, the caster deck floor 104 is configured to accommodate the pallet 106. The pallet 106 includes a top portion 130 and a bottom portion 132. The top portion 130 is for receiving loads. The bottom portion 132 interacts with the first type of wheel 110 and the second type of wheel 114 of the caster deck floor 104. The caster deck floor 104 facilitates efficient movement of the wheelless dolly 102 and the pallet 106 within the facility 100. The combination of the first type of wheel 110 on the floor 108 and the second type of wheel 114 in the dock 112 allow for smooth transitions and precise maneuvering of loads throughout the caster deck floor 104.

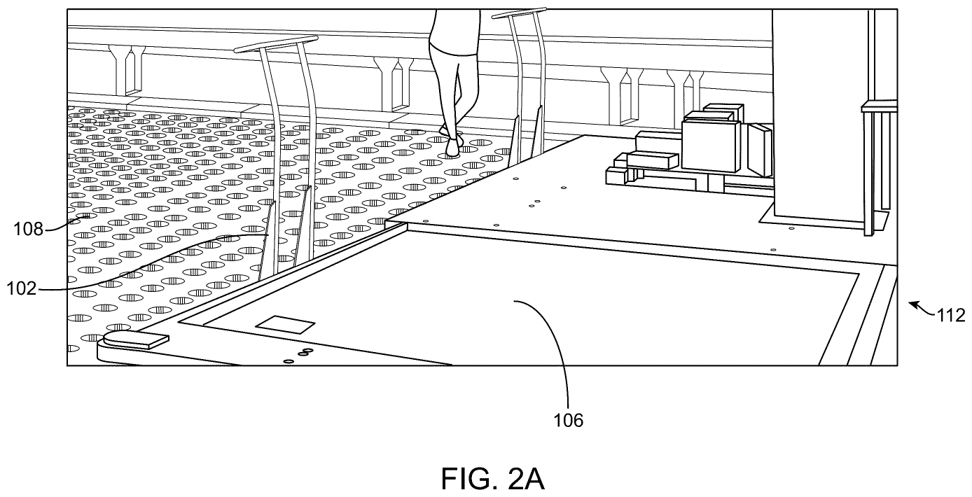

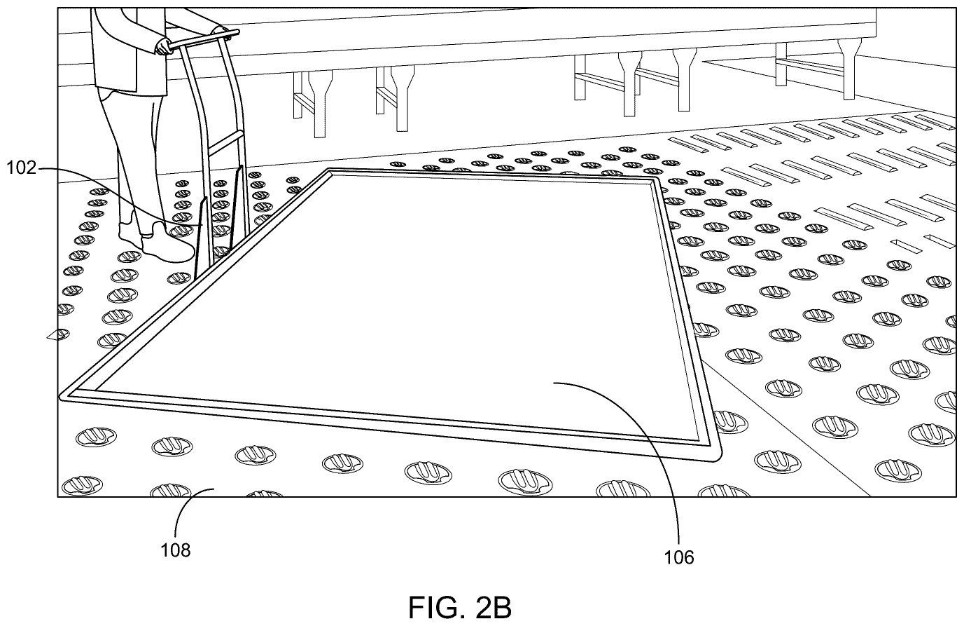

In some implementations, the pallet 106 is a Unit Load Device (ULD) pallet. ULD pallets are comprised of sheets of aluminum with rims to lock onto cargo net lugs. The pallet 106 can be designed to create a friction fit with a top surface of a planar base of the wheelless dolly 102, as shown in FIG. 2A. In some implementations, different types of pallets may be used with the wheelless dolly 102. For example, the pallet 106 may be a wooden pallet, a plastic pallet, or a metal pallet. The pallet 106 may have various dimensions and weight capacities to accommodate different types of loads. In some implementations, the loads may include packages, products, raw materials, or equipment. For example, the pallet 106 may carry boxed items, loose goods, machinery parts, or bulk materials. The versatility of the pallet 106 and the wheelless dolly 102 system allows for efficient handling of diverse cargo types within the facility 100.

FIG. 2A depicts the wheelless dolly 102 of FIG. 1 positioned under the pallet 106. The wheelless dolly 102 interacts with the bottom portion 132 of the pallet 106 to maneuver the pallet 106 within the caster deck floor 104. In particular, the wheelless dolly 102 create a friction fit with the bottom portion 132 of the pallet 106. The wheelless dolly 102 can be operated to remove the pallet 106 from the dock 112 to the floor 108 to move the pallet 106 and the load on the pallet 106 to its destination (e.g., another dock, a container, a vehicle, a storage location, etc.).

FIG. 2B depicts the wheelless dolly 102 of FIG. 1 positioned under the pallet 106 on the caster deck floor 104. In particular, the wheelless dolly 102 is holding the pallet 106 and maneuvering the dolly 102 within the floor 108 to transfer the pallet 106 to a destination.

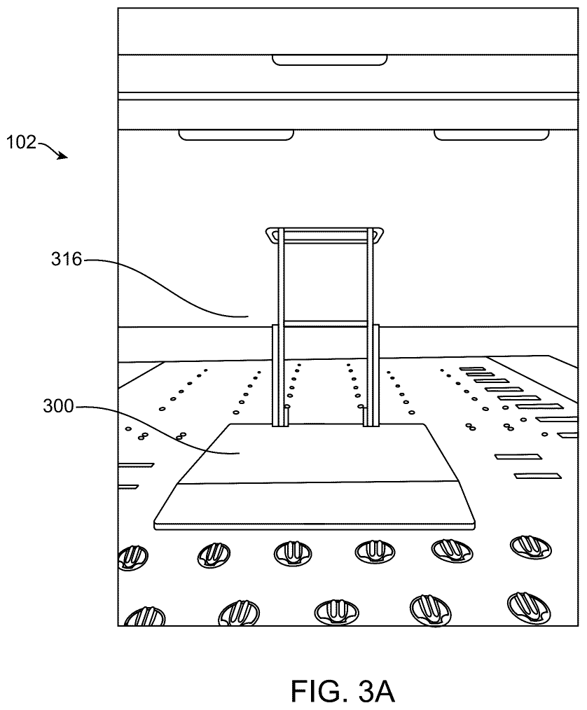

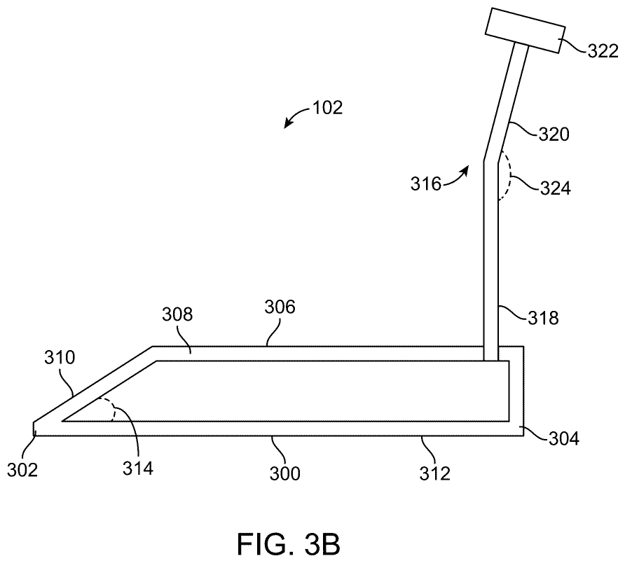

FIGS. 3A and 3B will be discussed in combination. FIG. 3A depicts a front view of the wheelless dolly 102 of FIG. 1 and FIG. 3B depicts a side view of the wheelless dolly 102 of FIG. 1. With reference to FIG. 3A and FIG. 3B, the wheelless dolly 102 includes a planar base 300 and an upright structure 316. The planar base 300 includes a first end 302 and a second end 304 opposite the first end 302.

The planar base 300 includes a top surface 306 and a bottom surface 312. In some implementations, the top surface 306 includes a first portion 308 and a second portion 310. The first portion 308 of the top surface 306 is flat and configured for carrying at least one of the pallets 106 or a load. The second portion 310 is tapered at the first end 302 of the planar base 300. In some implementations, the second portion 310 is tapered at an angle between 5 degrees and 40 degrees relative to the bottom surface 312. The dock 112 is configured to house the pallet 106. The top surface 306 of the planar base 302 is configured to create a friction fit with the bottom surface 132 of the pallet 106. The top surface 130 of the pallet 106 is at the same height 126 as the elevated surface 124 to enable placement of items on the pallet 106. The second portion 310 (e.g., the tapered portion) of the planar base 300 is angled to enable the wheelless dolly 102 to be positioned under the pallet 106 in the recess and engage the bottom surface of the pallet with the first portion of the top surface of the planar base.

The bottom surface 312 of the planar base 300 may be flat. The bottom surface 312 of the planar base 300 is configured to interact with the first type of wheel 110 and the second type of wheel 114. An angle 314 may be formed between the bottom surface 312 and the first portion 308 of the top surface 306 due to the tapered second portion 310. The angle 314 may vary based on the thickness of the planar base 300 and the degree of taper of the second portion 310. For example, as the thickness of the planar base increases or decreases so does the angle 314. The angle 314 can be adjusted regardless of thickness. For example, the angle 314 can be adjusted to create a taper of the second portion 310.

The upright structure 316 is coupled to the planar base 300 at the second end 304. The upright structure 316 includes a first portion 318, a second portion 320, and a third portion 322. The first portion 318 extends upwards from the top surface 306 of the planar base 300. In some implementations, the first portion 318 extends perpendicular to the top surface 306.

The second portion 320 is angled relative to the first portion 318 in a direction away from the second end 304 of the planar base 300. In some implementations, the second portion 320 is at an angle 324 relative to the first portion 318 that is between 5 degrees and 90 degrees. This configuration mitigates the feet of a user from hitting the planar base 300 while operating the wheelless dolly 102.

The third portion 322 is coupled to the second portion 320 and extends laterally across the second portion 320, thereby forming a handle configured for maneuvering the wheelless dolly 102 along the caster deck floor 104. The third portion 322 includes a surface that an individual operating the wheelless dolly 102 can interact with to maneuver the dolly 102 within the caster deck floor 104.

During operation, the wheelless dolly 102 may be maneuvered by an individual using the upright structure 316 to position the wheelless dolly 102 within the dock 112 of the caster deck floor 104. In some implementations, the wheelless dolly 102 may be slid underneath the pallet 106 while the pallet 106 is positioned in the recess 122 of the dock 112. The tapered second portion 310 of the planar base 300 may facilitate the positioning of the wheelless dolly 102 under the pallet 106. The first portion 308 of the top surface 306 of the planar base 300 may engage with the bottom portion 132 of the pallet 106.

Once engaged, the wheelless dolly 102 and the pallet 106 may be maneuvered as a unit. The individual operating the wheelless dolly 102 may use the third portion 322 of the upright structure 316 as a handle to guide the movement. The second type of wheel 114 in the dock 112 may enable forward operation in the forward direction 116 and rearward operation in the rearward direction 118 of the wheelless dolly 102 within the dock 112.

As the wheelless dolly 102 and the pallet 106 reach the transition point 120, the first wheel 110 on the floor 108 may facilitate a smooth transition from the dock 112 to the floor 108. The first wheel 110 may enable operation of the wheelless dolly 102 within a 360-degree range of motion on the floor 108, allowing for precise maneuvering of the pallet 106 and its load within the facility 100.

In some implementations, the elevated surface 124 of the dock 112 may be at the same height 126 as the top portion 130 of the pallet 106. This configuration may allow for easy loading and unloading of items onto the pallet 106 while the pallet 106 is positioned in the dock 112. The walking surface 128 may enable individuals to move around the caster deck floor 104 without interfering with the operation of the wheelless dolly 102.

The wheelless dolly 102 may be used to transport the pallet 106 and its load to various locations within the facility 100. The bottom surface 312 of the planar base 300 may interact with the first type of wheel 110 and the second type of wheel 114 of the caster deck floor 104, allowing for smooth movement across different surfaces.

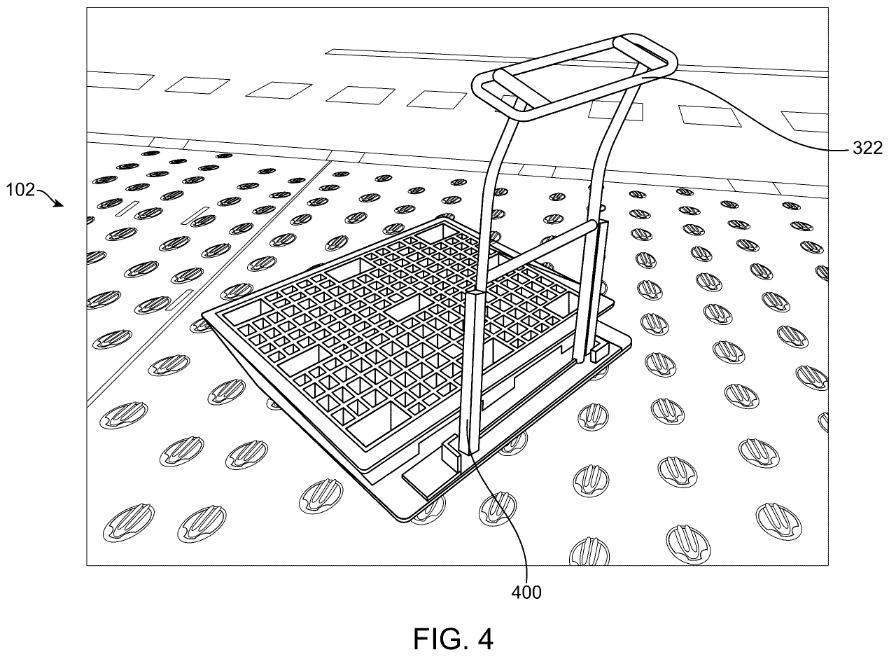

FIG. 4 depicts a rear perspective view of the wheelless dolly 102 of FIG. 1. The third portion 322 is illustrated with an embodiment for the surface that a user can interact with. The third portion 322 include rectangular openings for a user's hands to be positioned in. However, the openings can be any type of shape to enable a user to interact with the third portion 322.

The wheelless dolly 102 includes reinforcement elements 400 that are coupled to the first portion 318 and the top surface 308 of the planar base 300 to reinforce the coupling of the first portion 318 to the top surface 308. The reinforcement elements 400 increase the structural integrity of the wheelless dolly 102 for maneuvering heavy pallets 106 and loads. In some implementations, the reinforcement elements 400 of the wheelless dolly 102 may provide additional structural support during the transportation of heavy loads on the pallet 106. The angle 324 between the first portion 318 and the second portion 320 of the upright structure 316 may allow the individual operating the wheelless dolly 102 to maintain a comfortable posture while maneuvering the pallet 106 and its load. In some implementations, the reinforcement elements 400 may be triangular supports that reinforce the coupling of the first portion 318 to the top surface 306.

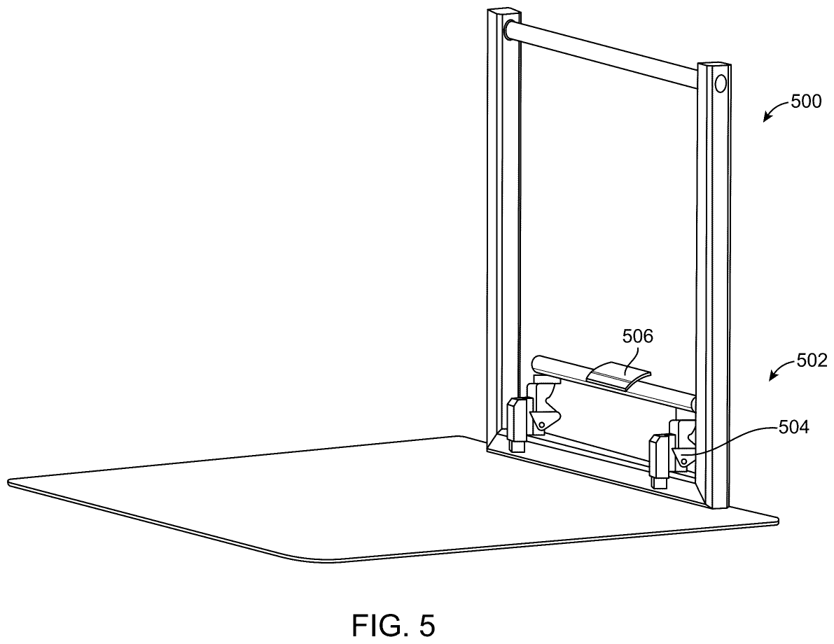

With reference to FIG. 5, an alternative embodiment of a wheelless dolly 500 is illustrated. The wheelless dolly 500 may include a clamping mechanism 502 in addition to the features described for the wheelless dolly 102 in previous embodiments. The clamping mechanism 502 may include a clamp 504 and a pedal 506. In some implementations, the clamp 504 may be positioned near the bottom of the upright structure 316 of the wheelless dolly 500. The pedal 506 may be located at the base of the upright structure 316, connected to the clamp 504 through an internal mechanism.

During operation, the wheelless dolly 500 may be positioned under the pallet 106 within the dock 112 of the caster deck floor 104. The pedal 506 may be operated to lift the clamp 504. In some implementations, when the pedal 506 is released, the clamp 504 may be positioned on the pallet 106 to secure the pallet 106 to the wheelless dolly 500.

The clamping mechanism 502 may provide additional stability when maneuvering the pallet 106 and its load within the facility 100. In some implementations, the clamping mechanism 502 may be particularly useful when transporting heavy or unstable loads across the caster deck floor 104.

The wheelless dolly 500 with the clamping mechanism 502 may be operated in a similar manner to the wheelless dolly 102 described in previous embodiments. The planar base of the wheelless dolly 500 may interact with the first wheel 110 on the floor 108 and the second wheel 114 in the dock 112, allowing for movement in the forward direction 116 and the rearward direction 118.

In some implementations, the clamping mechanism 502 may be designed to accommodate various pallet sizes and configurations. The clamp 504 may be adjustable to securely hold different types of pallets 106, enhancing the versatility of the wheelless dolly 500.

The pedal 506 of the clamping mechanism 502 may be operated by foot, allowing the individual maneuvering the wheelless dolly 500 to maintain a grip on the upright structure while engaging or disengaging the clamp 504. This feature may improve the ergonomics and ease of use of the wheelless dolly 500.

In some implementations, the wheelless dolly 500 with the clamping mechanism 502 may be particularly useful for operations involving the transition point 120 between the floor 108 and the dock 112. The secure attachment provided by the clamp 504 may help maintain the position of the pallet 106 relative to the wheelless dolly 500 during this transition.

The wheelless dolly 500 may retain the tapered design of the planar base at the first end, facilitating positioning under the pallet 106 in the recess 122 of the dock 112. The clamping mechanism 502 may then be engaged to secure the pallet 106 for transport across the caster deck floor 104.

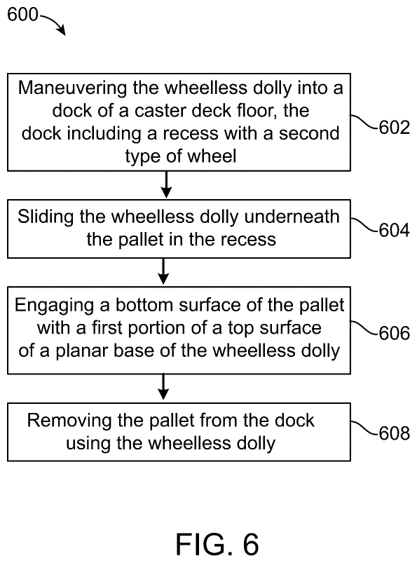

FIG. 6 illustrates a flowchart of an example method 600, according to embodiments disclosed herein. The method 600 is directed to moving the pallet 106 using the wheelless dolly 102. The method 600 includes step 602 of maneuvering the wheelless dolly into a dock of a caster deck floor, the dock including a recess with a second type of wheel. In particular, the method 600 includes maneuvering the wheelless dolly 102 into the dock 112 of the caster deck floor 112, and the dock 112 including the recess 122 with the second type of wheel 114.

The method 600 includes step 604 of sliding the wheelless dolly underneath the pallet in the recess. In particular, the method 600 includes sliding the wheelless dolly 102 underneath the pallet 106 in the recess 122.

The method 600 includes step 606 of engaging a bottom surface of the pallet with a first portion of a top surface of a planar base of the wheelless dolly. In particular, the method 600 includes engaging the bottom surface 132 of the pallet 106 with the first portion 308 of the top surface 306 of the planar base 300 of the wheelless dolly 102.

The method 600 includes step 606 of removing the pallet from the dock using the wheelless dolly. In particular, the method 600 includes removing the pallet 106 from the dock 112 using the wheelless dolly 102.

In some implementations, the method 600 includes maneuvering the dolly 102 with the pallet 106 on a floor 108 of the caster deck floor 104. The floor 108 including the first type of wheel 110 enabling operation of the wheelless dolly 102 within a 360-degree range of motion.

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A wheelless dolly configured for use with a caster deck floor, the wheelless dolly comprising:
a planar base that is tapered at a first end; and
an upright structure coupled to the planar base at a second end opposite the first end, the structure comprising:
a first portion extending upwards from a top surface of the planar base,
a second portion angled relative to the first portion in a direction away from the second end of the planar base, and
a third portion coupled to the second portion extending laterally across the second portion, thereby forming a handle configured for maneuvering the wheelless dolly along the caster deck floor.

2. The wheelless dolly of claim 1, wherein the planar base further comprises:
a top surface including a first portion configured for carrying packages and a second portion that is tapered at the first end; and
a bottom surface, wherein the bottom surface of the planar base is flat.

3. The wheelless dolly of claim 2, wherein the first portion of the top surface is flat and configured for carrying at least one of a pallet, or a load.

4. The wheelless dolly of claim 2, wherein the second portion is tapered at an angle between 5 degrees and 40 degrees.

5. The wheelless dolly of claim 1, wherein the first portion of the upright structure is coupled to the planar base via the top surface adjacent a first side of the planar base and extends perpendicular to the top surface.

6. The wheelless dolly of claim 5, wherein the second portion of the upright structure is angled relative to the top surface of the base at an angle between 5 degrees and 45 degrees and extends beyond the first side of the base to enable an individual to operate the wheelless dolly to mitigate the individual from engaging the planar base.

7. The wheelless dolly of claim 6, wherein the handle of the third portion of the upright structure includes a surface that an individual operating the wheelless dolly can interact with to maneuver the dolly within the caster deck floor.

8. A system for moving packages, comprising:
a caster deck floor including a floor with a first type of wheel and a dock with a second type of wheel; and
a wheelless dolly including:
a planar base that is tapered at a first end of the planar base; and
an upright structure coupled to the planar base at a second end of the planar base opposite the first end.

9. The system of claim 8, wherein the first type of wheel enables operation of the wheelless dolly within a 360-degree range of motion.

10. The system of claim 8, wherein the second type of wheel is a roller wheel that enables forward and rearward operation of the wheelless dolly within the dock.

11. The system of claim 8, wherein the dock includes a recess and an elevated surface, the recess housing the second type of wheel.

12. The system of claim 11, wherein the planar base includes a top surface, wherein the dock is configured to house a pallet, and the top surface of the planar base is configured to create a friction fit with a bottom surface of the pallet, wherein a top surface of the pallet is at the same height as the elevated surface to enable placement of items on the pallet.

13. The system of claim 12, wherein the planar base of the wheelless dolly includes a top surface with a first portion that is flat and configured for carrying packages, and a second portion that is tapered at the first ed of the planar base.

14. The system of claim 13, wherein the tapered portion of the planar base is angled to enable the wheelless dolly to be positioned under the pallet in the recess and engage the bottom surface of the pallet with the first portion of the top surface of the planar base.

15. A method of moving a pallet using a wheelless dolly, the method comprising:
maneuvering the wheelless dolly into a dock of a caster deck floor, the dock including a recess with a second type of wheel;
sliding the wheelless dolly underneath the pallet in the recess;
engaging a bottom surface of the pallet with a first portion of a top surface of a planar base of the wheelless dolly; and
removing the pallet from the dock using the wheelless dolly.

16. The method of claim 15, further comprising maneuvering the dolly with the pallet on a floor of the caster deck floor, the floor including a first type of wheel enabling operation of the wheelless dolly within a 360-degree range of motion.

17. The method of claim 16, wherein the second type of wheel is a roller wheel that enables forward and rearward operation of the wheelless dolly within the dock.

18. The method of claim 17, wherein the dock includes an elevated surface, and a top surface of the pallet is at the same height as the elevated surface to enable placement of items on the pallet.

19. The method of claim 18, wherein the planar base of the wheelless dolly includes a tapered portion angled to enable the wheelless dolly to be positioned under the pallet in the recess of the dock.

20. The method of claim 19, wherein the wheelless dolly includes an upright structure with a first portion extending upwards from a top surface of the planar base, a second portion angled relative to the first portion in a direction away from the second end of the planar base, and a third portion coupled to the second portion, thereby forming a handle for maneuvering the wheelless dolly.
